(19) United States
(12) Patent Application Publication
(10) Pub. No.: US 2013/0303952 A1
(43) Pub. Date: Nov. 14, 2013

(54) MASSAGE SHOES

(71) Applicant: Yaffa Golan, Tel Aviv (IL)

(72) Inventor: Yaffa Golan, Tel Aviv (IL)

(73) Assignee: YAFFA GOLAN (1994) LTD., Tel Aviv (IL)

(21) Appl. No.: 13/979,493

(22) PCT Filed: Jan. 5, 2012
(86) PCT No.: PCT/IL12/00004

§ 371 Date: Jul. 12, 2013

Related U.S. Application Data
(60) Provisional application No. 61/435,884, filed on Jan. 25, 2011.

(51) Int. Cl. A61H 23/02

(52) U.S. Cl. CPC A61H 23/02
USPC 601/46

(57) ABSTRACT

A massaging shoe including a shoe body portion formed of a vibration transmitting material and having an interior surface which includes a multiplicity of integrally formed raised surface elements and a vibrator operative to generate vibrations, the vibrations being transmitted via the vibration transmitting material and the integrally formed raised surface elements to a foot of a wearer of the shoe.

### REFERENCE TO RELATED APPLICATIONS

Reference is made to U.S. Provisional Patent Application Ser. No. 61/435,884, filed Jan. 25, 2011 and entitled “MASSAGE SHOES”, the disclosure of which is hereby incorporated by reference and priority of which is hereby claimed pursuant to 37 CFR 1.78(a) (4) and (5)(i).

### FIELD OF THE INVENTION

The present invention relates to massaging shoes systems.

### BACKGROUND OF THE INVENTION

The following patent publications are believed to represent the current state of the art:

U.S. Pat. Nos. 5,113,850 and 6,464,654.

### SUMMARY OF THE INVENTION

The present invention provides massaging shoes and massaging shoe systems.

There is thus provided in accordance with a preferred embodiment of the present invention a massaging shoe including a shoe body portion formed of a vibration transmitting material and having an interior surface which includes a multiplicity of integrally formed raised surface elements and a vibrator operative to generate vibrations, the vibrations being transmitted via the vibration transmitting material and the integrally formed raised surface elements to a foot of a wearer of the shoe.

In accordance with a preferred embodiment of the present invention the shoe also includes a massaging control system operative to control the vibrator of the at least one massaging shoe. Preferably, the vibration transmitting material is an elastomeric material. Preferably, the vibrator includes an internal power source and an integral motor mechanism operative to generate the vibrations.

Preferably, the interior surface includes surface portions which engage the sides and top of the foot of the wearer of the shoe. Preferably, the interior surface also includes a bottom surface portion which engages the underside of the foot of the wearer of the shoe. Alternatively, the integrally formed raised surface elements are also formed on a shoe insert which is inserted into the shoe.

Preferably, the shoe also includes at least one elastic gore. Additionally, the shoe also includes at least one fastening strap. Preferably, the shoe also includes an electrical connection operable for connecting the shoe to an external power source. Preferably, the internal power source is a chargeable power source. Preferably, the chargeable power source is a battery. Preferably, the integral motor mechanism includes an integrated circuit operative to control the integral motor mechanism.

Preferably, the integral motor mechanism also includes at least two discrete eccentric drive motors, each of the motors operable to generate vibrations which are transmitted throughout respective forward and rearward parts of the shoe. Preferably, the integral motor mechanism also includes two drive motor casings for encasing the eccentric drive motors. Preferably, the casings are operative to acoustically insulate the drive motors.

In accordance with a preferred embodiment of the present invention the combination of the vibration transmitting material and the two discrete eccentric drive motors are together operative to achieve generally homogeneous dispersion of the vibrations throughout the shoe to the multiplicity of integrally formed raised surface elements.

There is also provided in accordance with another preferred embodiment of the present invention a foot massaging system including at least one massaging shoe, the shoe including a shoe body portion formed of a vibration transmitting material and having an interior surface which includes a multiplicity of integrally formed raised surface elements and a vibrator operative to generate vibrations, the vibrations being transmitted via the vibration transmitting material and the integrally formed raised surface elements to a foot of a wearer of the shoe, and a massaging control system operative to control the vibrator of the shoe.

In accordance with a preferred embodiment of the present invention the shoe also includes a massaging control subsystem operative to control the vibrator of the at least one massaging shoe. Preferably, the system also includes a battery-powered remote control device operable for controlling the massaging control subsystem of the at least one massaging shoe. Preferably, the remote control device is operable to configure the massaging control subsystem of the at least one massaging shoe to operate the vibrator at one of several operating speeds, and to operate the vibrator for the duration of a selectable time period.

Preferably, the vibration transmitting material is an elastomeric material. Preferably, the vibrator includes an internal power source and an integral motor mechanism operative to generate the vibrations.

Preferably, the interior surface includes surface portions which engage the sides and top of the foot of the wearer of the shoe. Preferably, the interior surface also includes a bottom surface portion which engages the underside of the foot of the wearer of the shoe. Alternatively, the integrally formed raised surface elements are also formed on a shoe insert which is inserted into the shoe.

Preferably, the shoe also includes at least one elastic gore. Preferably, the shoe also includes at least one fastening strap. Preferably, the shoe also includes an electrical connection operable for connecting the shoe to an external power source. Preferably, the internal power source is a chargeable power source. Preferably, the chargeable power source is a battery.

Preferably, the integral motor mechanism includes an integrated circuit operative to control the integral motor mechanism. Preferably, the integral motor mechanism also includes at least two discrete eccentric drive motors, each of the motors operable to generate vibrations which are transmitted throughout respective forward and rearward parts of the shoe. Preferably, the integral motor mechanism also includes two drive motor casings for encasing the eccentric drive motors. Preferably, the casings are operative to acoustically insulate the drive motors.

In accordance with a preferred embodiment of the present invention the combination of the vibration transmitting material and the two discrete eccentric drive motors are together operative to achieve generally homogeneous dispersion of the vibrations throughout the shoe to the multiplicity of integrally formed raised surface elements.

### BRIEF DESCRIPTION OF THE DRAWINGS

The present invention will be understood and appreciated more fully from the following detailed description, taken in conjunction with the drawings in which:

FIG. 1A is a simplified illustration of a pair of foot massaging system constructed and operative in accordance with a preferred embodiment of the present invention; and

FIG. 1B is a simplified sectional illustration of the interior structure of the massage shoe of FIG. 1A, taken along lines IB-IB in FIG. 1A.

### DETAILED DESCRIPTION OF PREFERRED EMBODIMENTS

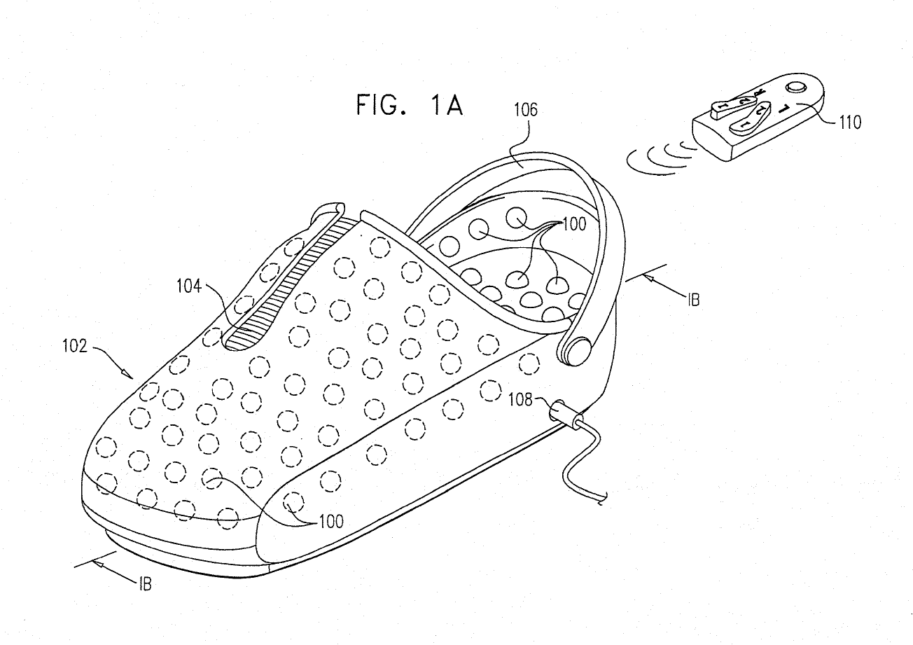

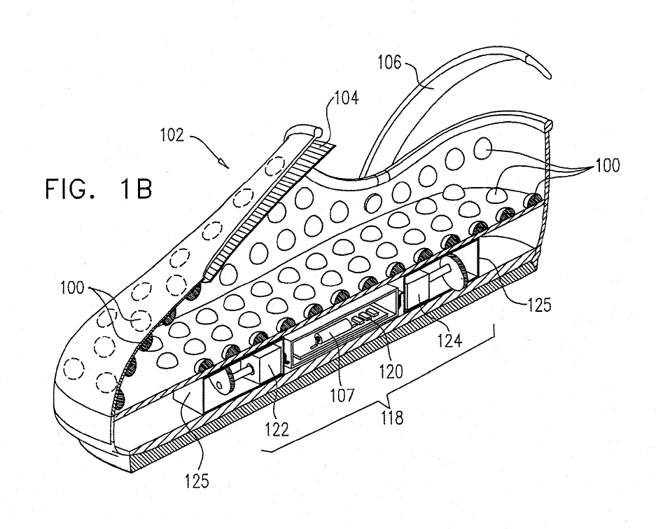

Reference is now made to FIG. 1A, which is a simplified illustration of a foot massaging system constructed and operative in accordance with a preferred embodiment of the present invention, and to FIG. 1B, which is a simplified sectional illustration of the interior structure of the massage shoe of FIG. 1A, taken along lines IB-IB in FIG. 1A.

The foot massaging system of FIGS. 1A & 1B preferably includes at least one massaging shoe, the shoe including a shoe body portion formed of a vibration transmitting material and having an interior surface which includes a multiplicity of integrally formed raised surface elements, and a vibrator operative to generate vibrations. The vibrations are preferably transmitted via the vibration transmitting material and the integrally formed raised surface elements to a foot of a wearer of the shoe, thereby providing a massaging sensation to the foot of the wearer of the shoe. The shoe preferably also includes a massaging control system operative to control the vibrator of the shoe.

The vibration transmitting material is preferably an elastomeric material such as ethylene-vinyl acetate. The vibrator preferably includes a power source and an integral motor mechanism which generates the vibrations.

As shown in FIG. 1A, a multiplicity of preferably integrally formed raised surface elements 100 are preferably dispersed over the entire interior surface of a massage shoe 102, including the portions engaging the underside, sides and top of the wearer's foot. Alternatively, the raised surface elements 100 engaging the underside of the wearer's foot may be integrally formed on a shoe insert which is inserted into shoe 102.

Preferably, an elastic gore 104 is formed in the top surface of shoe 102 and provides for snug fitting of shoe 102 to a wearer's foot. Additionally, a fastening strap 106 is preferably provided for further fastening of shoe 102 to the wearer's foot.

A chargeable power source 107 (FIG. 1B), such as a battery, is preferably integrally provided for powering shoe 102. Preferably, an electrical connection 108 is provided for connecting chargeable power source 107 to an external power source, thereby enabling charging thereof.

Preferably, a battery-powered remote control device 110 is provided for controlling the motor mechanism of each of a pair of shoes 102. Preferably, remote control device 110 can be used to set the motor mechanism of each of a pair of shoes 102 to operate at one of several operating speeds, and to operate for the duration of a selectable time period.

Turning now to FIG. 1B, it is shown that a motor mechanism 118 operative to generate vibrations is embedded within the sole of shoe 102. Motor mechanism 118 preferably includes an integrated circuit 120 for receiving control inputs from remote control device 110 operative to control motor mechanism 118. Motor mechanism 118 includes two discrete eccentric drive motors 122 and 124 which each provide vibrations that are transmitted throughout the forward and rearward parts of shoe 102, respectively. Drive motor casings 125 are provided for encasing drive motors 122 and 124, and to thereby acoustically insulate drive motors 122 and 124. Chargeable battery 107 chargeable via electrical connection 108 (FIG. 1A) provides power to integrated circuit 120 and to motors 122 and 124.

It is a particular feature of the present invention that the combination of the vibration transmitting properties of the elastomeric material and the two discrete eccentric drive motors 122 and 124 together achieve generally homogeneous dispersion of vibrations throughout massage shoe 102 to the multiplicity of integrally formed raised surface elements 100, thereby providing a massaging sensation to the foot of the wearer of shoe 102, not only to the underside of the foot, but also to the side and top portions of the wearer's foot. It is another particular feature of the present invention that the generally homogeneous dispersion of vibrations throughout massage shoe 102 to the multiplicity of integrally formed raised surface elements 100 is operative to improve blood circulation in the wearer's foot.

It will be appreciated by persons skilled in the art that the present invention is not limited by what has been particularly shown and described hereinabove. Rather, the invention also includes various combinations and subcombinations of the features described hereinabove as well as modifications and variations thereof, which would occur to persons skilled in the art upon reading the foregoing and which are not in the prior art.

1-36. (canceled)

37. A massaging shoe comprising:
a shoe body portion formed of a vibration transmitting material and having an interior surface which comprises a multiplicity of integrally formed raised surface elements; and
a vibrator operative to generate vibrations, said vibrations being transmitted via said vibration transmitting material and said integrally formed raised surface elements to a foot of a wearer of said shoe.

38. A massaging shoe according to claim 37 and also comprising a massaging control system operative to control said vibrator of said at least one massaging shoe.

39. A massaging shoe according to claim 37 and wherein said vibration transmitting material is an elastomeric material.

40. A massaging shoe according to claim 37 and wherein said vibrator comprises at least one of a chargeable battery and an electrical connection operable for connecting said shoe to an external power source, and an integral motor mechanism powered by at least one of said chargeable battery and said external power source, said integral motor mechanism operative to generate said vibrations.

41. A massaging shoe according to claim 37 and wherein said interior surface comprises surface portions which are adapted to engage the sides and top of the foot of the wearer of said shoe.

42. A massaging shoe according to claim 41 and wherein said interior surface also comprises a bottom surface portion which engages the underside of the foot of the wearer of said shoe.

43. A massaging shoe according to claim 37 and wherein said integrally formed raised surface elements are also formed on a shoe insert which is inserted into said shoe.

44. A massaging shoe according to claim 40 and wherein said integral motor mechanism comprises an integrated circuit operative to control said integral motor mechanism.

45. A massaging shoe according to claim 40 and wherein said integral motor mechanism comprises at least two discrete eccentric drive motors, each of said motors operable for generating vibrations which are transmitted throughout respective forward and rearward parts of said shoe.

46. A massaging shoe according to claim 45 and wherein said integral motor mechanism also comprises two drive motor casings for encasing said eccentric drive motors, said casings being operative to acoustically insulate said drive motors.

47. A massaging shoe according to claim 45 and wherein the combination of said vibration transmitting material and said two discrete eccentric drive motors are together operative to achieve generally homogeneous dispersion of said vibrations throughout said shoe to said multiplicity of integrally formed raised surface elements.

48. A foot massaging system comprising:
at least one massaging shoe, said shoe comprising:
a shoe body portion formed of a vibration transmitting material and having an interior surface which comprises a multiplicity of integrally formed raised surface elements; and
a vibrator operative to generate vibrations, said vibrations being transmitted via said vibration transmitting material and said integrally formed raised surface elements to a foot of a wearer of said shoe; and
a massaging control system operative to control said vibrator of said shoe.

49. A foot massaging system according to claim 48 and wherein said shoe also comprises a massaging control subsystem operative to control said vibrator of said at least one massaging shoe and a battery-powered remote control device operable for controlling said massaging control subsystem of said at least one massaging shoe, said remote control device being operable for configuring said massaging control subsystem of said at least one massaging shoe to operate said vibrator at one of several operating speeds and to operate said vibrator for the duration of a selectable time period.

50. A foot massaging system according to claim 48 and wherein said vibration transmitting material is an elastomeric material.

51. A foot massaging system according to claim 48 and wherein said vibrator comprises at least one of a chargeable battery and an electrical connection operable for connecting said shoe to an external power source, and an integral motor mechanism powered by at least one of said chargeable battery and said external power source, said integral motor mechanism operative to generate said vibrations.

52. A foot massaging system according to claim 48 and wherein said interior surface comprises surface portions which engage the sides and top of the foot of the wearer of said shoe and a bottom surface portion which engages the underside of the foot of the wearer of said shoe.

53. A foot massaging system according to claim 48 and wherein said integrally formed raised surface elements are also formed on a shoe insert which is inserted into said shoe.

54. A foot massaging system according to claim 51 and wherein said integral motor mechanism comprises an integrated circuit operative to control said integral motor mechanism.

55. A foot massaging system according to claim 51 and wherein said integral motor mechanism comprises at least two discrete eccentric drive motors, each of said motors operable for generating vibrations which are transmitted throughout respective forward and rearward parts of said shoe, and two drive motor casings for encasing said eccentric drive motors, said casings being operative to acoustically insulate said drive motors.

56. A foot massaging system according to claim 55 and wherein the combination of said vibration transmitting material and said two discrete eccentric drive motors are together operative to achieve generally homogeneous dispersion of said vibrations throughout said shoe to said multiplicity of integrally formed raised surface elements.
